(19) United States
(12) Patent Application Publication
(10) Pub. No.: US 2018/0264370 A1
(43) Pub. Date: Sep. 20, 2018

(54) Peel-Away Surprise Doll

(71) Applicant: MGA Entertainment, Inc., Van Nuys, CA (US)

(72) Inventors: Blanche Consorti, Los Angeles, CA (US); Marc Goodrich, Los Angeles, CA (US); Paula Garcia, Burbank, CA (US)

(73) Assignee: MGA Entertainment, Inc., Van Nuys, CA (US)

(21) Appl. No.: 15/925,366

(22) Filed: Mar. 19, 2018

Related U.S. Application Data
(60) Provisional application No. 62/473,995, filed on Mar. 20, 2017.

(51) Int. Cl. A63H 3/36; B32B 7/06; B32B 27/06; B32B 43/00

(52) U.S. Cl. CPC A63H 3/36; B32B 43/006; B32B 27/06; B32B 7/06

(57) ABSTRACT

A toy figure such as a doll has at least a portion thereof such as a head covered in a conformal coating that is easily peeled away. The coating has separation lines such as die cuts in it that allow different portions of the coating to be independently peeled away. The different portions of the coating have tabs, or string embedded therein, or other means for grasping those portions respectively. The child peels away one portion of the coating to reveal a first part of the figure, then another portion of the coating to reveal more of the figure, and finally the character is revealed once all of the coating portions have been peeled away. In this way the figure is slowly revealed to the child in an interactive process that involves the child. The slow reveal helps to arouse the child's sense of excitement and anticipation as the child slowly and serially uncovers and thus reveals different parts of the doll. The coating can have features of its own to give the character particular features or an appearance that can be peeled away.

### CROSS-REFERENCE TO RELATED APPLICATIONS

This application claims priority from U.S. provisional patent application No. 62/473,995 filed Mar. 20, 2017.

### BACKGROUND OF THE INVENTION

### 1. Field of the Invention

This invention relates to the field of toys. More particularly, this invention relates to the field a toy character which has one or more shape-conforming coverings that a child peels away to reveal the character.

### 2. Description of Related Art

Children enjoy surprises, and enjoy toys that contain an element of surprise. U.S. Patent Publication No. 2002/0168919 by Perkins discloses a plush toy having a prize hidden in an interior compartment.

### SUMMARY OF THE INVENTION

The present invention is of a toy character such as a doll which has one or more shape-conforming coverings that a child peels away in serial, such that the physical characteristics of the doll are slowly revealed to the child. The serial and slow reveal heightens interest and excitement for the child as she peels away the different sections to see what character she has received, and the appearance of the doll changes as she removes those sections.

In an exemplary embodiment, the toy is a doll figure that is partly or fully covered in a coating comprising a polymer that has been melted and poured or sprayed onto the doll, or wax which has been melted and poured or sprayed onto the doll so that the coating conforms to the outer surface of the doll. At least the inwardmost portion of the coating conforms in shape to an exterior surface of the doll underneath, and thus is a conformal coating. The coating has perforations or die cuts in it to allow different portions that cover respectively different parts of the doll to be removed from the doll independently. The different coating portions can have upwardly and/or outwardly extending tabs, or loose ends of string, or other means to facilitate independent removal of the different coating portions by peeling those different portions away one after the other. Thus, after the doll has been purchased in the store and its traditional packaging such as cardboard and/or plastic clamshell packaging has been removed, the child must further peel away different portions of the coating from the different parts of the doll. She does so, for example, by first grasping the tab that corresponds to the coating over the doll's left eye and peeling the coating away, then peeling away the coating that cover's the doll's right eye, then peeling away the coating that covers the doll's hair, then perhaps torso, then feet, etc.

Additionally, the coating or wrapping on the figure can have features that give the figure a first appearance, with that appearance changing as the coating is removed so that the character seems to transform from one character to another.

Exemplary embodiments of the invention will be further described below with reference to the drawings, in which like numbers refer to like parts. The drawing figures might not be to scale, and certain components may be shown in generalized or schematic form and identified by commercial designations in the interest of clarity and conciseness.

### BRIEF DESCRIPTION OF THE DRAWINGS

FIG. 1 is a front elevation view of an exemplary embodiment of the present invention, with the doll covered by the coating.

FIG. 2 shows the doll of FIG. 1 with a user having peeled away a first section of coating, and in the process of peeling away a second section of coating.

FIG. 3 shows the doll of FIG. 1 with the user having peeled away several sections of coating.

FIG. 4 shows the doll of FIG. 1 with the user having peeled away additional layers of coating.

FIG. 5 shows the doll of FIG. 1 with the user having peeled away all of sections of coating, and with the character now fully revealed.

### DETAILED DESCRIPTION OF THE PREFERRED EMBODIMENTS

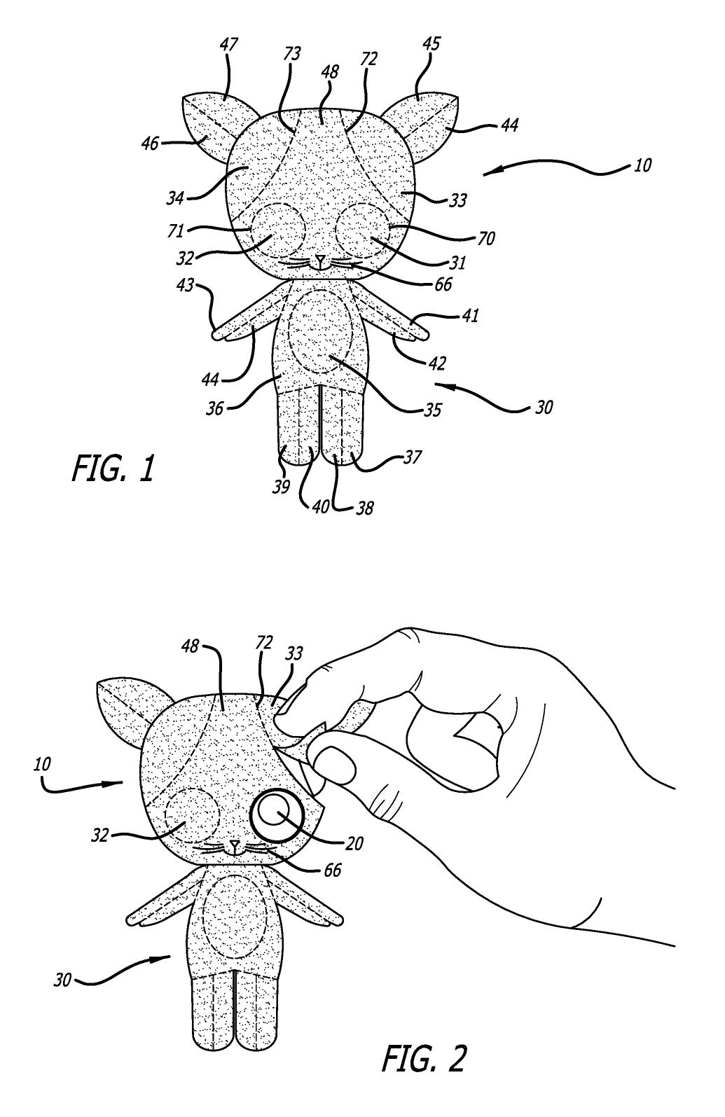

FIG. 1 shows the toy character figure or doll 10 in its coating-covered state as the child might receive it from the store and withdraw it from the usual store packaging. In this embodiment various separable sections 31-48 of coating 30 completely cover the doll 10. Coating 30 has weakened separation lines that define the different sections of coating, including weakened separation lines 70, 71 seen in the figure that delineate eye-covering sections 31 and 32 from face-covering section 48, and separation lines 72, 73 located on the upper part of the doll's head 14. The weakened separation lines can be stamped perforation lines, die-cut lines, or other type of weakened separation lines. They could even be lines or areas completely devoid of coating. Forming the separation lines should be performed carefully, controlling the depth of the perforations or die cut so as to avoid cutting or otherwise damaging the doll's outer skin or surface.

In this embodiment the coating 30 includes sections 44/45 and 46/47 that define ears. Additionally, whiskers 66 are imprinted on the coating such as by printing or painting, or whiskers 66 could be strands of whisker-like material embedded in or adhered to the coating. Additional features shown are a nose and mouth, which could also be imprinted or painted on coating 30, or embedded in or affixed to the coating. In this embodiment the ears 44/45 and 46/47, and whiskers 66 together with the nose and mouth, give the coating-covered figure the appearance of a kitten. Similarly, the coating and any other features imprinted, painted, or adhered thereto could give the character the appearance of a dog, a rabbit, a dragon, a monster, or any other character. In general, one or more portions of the coating 30 can include one or more animal features such as a whiskers, ears, nose, tail, etc., but the doll 10 has no such corresponding animal feature(s), or has similar but different features such as differently shaped ears or mouth.

In this way, the doll 10 without the coating 30 on it can have the appearance of a first species, in this case of a human, and the coating 30 gives to doll 10 the appearance of a second species, in this case a kitten. The result is that as the child removes the coating 30, the doll appears to transform from a first species to a second species, or more generally from one character to another.

More generally, the coating could have features and characteristics that make the underlying doll 10 take on various different appearances, including being of different animals/robots/humans/humanoids, or having different expressions or facial features such as a moustache or large pouty lips, a smile, or accessories such as earrings or sunglasses.

FIG. 2 shows the doll 10 of FIG. 1 with a user having peeled away a first section 31 of coating that previously covered first eye 20, and the user is in the process of peeling away a second section 33 of coating that covers a portion of the doll's head. The weakened separation line 72 assists the user in removing section 33 of coating, such that the user can easily and without needing any tools peel away and remove a section such as section 33 of coating 30 from an exterior surface of the character thus revealing a portion of the character below it, without also peeling away an adjacent coating portion such as portions 44, 45, and 48.

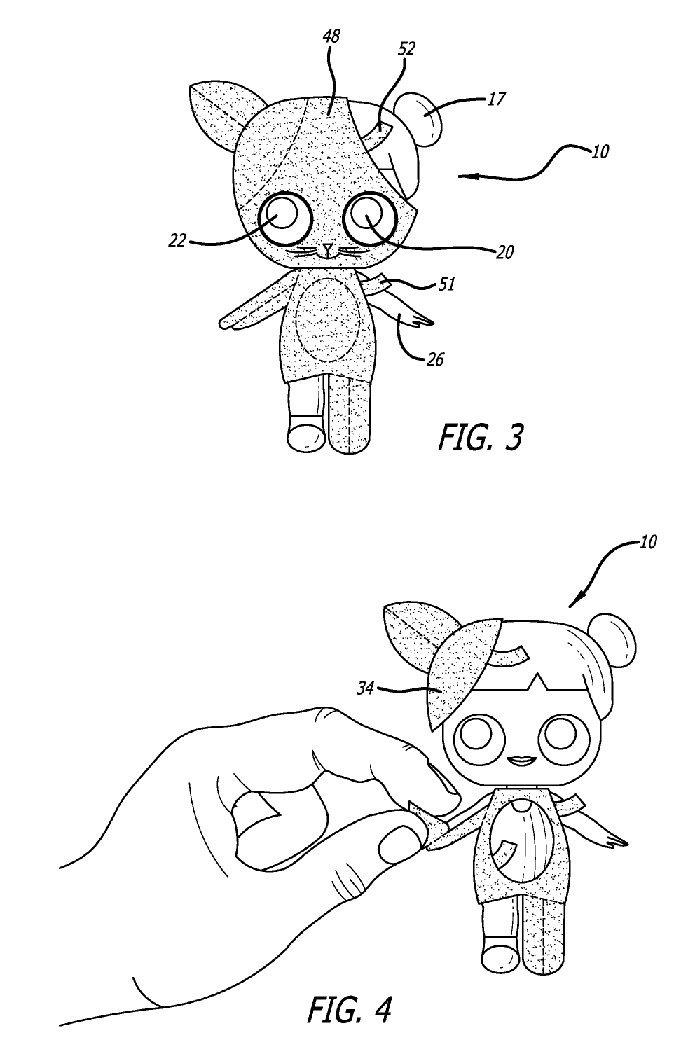

FIG. 3 shows the character 10 of FIG. 1 with the user having peeled away several sections of coating. Both eyes 20 and 22 are now visible, as is part of the doll's head 14 and hair including the doll's pigtail 17, as well as arm 26. The hair on the doll's head 14 could be either actual strands of hair-like material, or could be merely plastic or other material that is shaped and/or colored to simulate hair.

Different sections of coating 31, 32 have been peeled away separately to separately reveal the doll's eyes 20, 22 while leaving most of the doll's face 18 still covered. Alternatively, a covering portion 31 could be removed to reveal one eye 20 of doll 10, with the coating section that covers the rest of the face including the coating over a second eye of the doll, such that the face and second eye 22 are revealed at the same time. One section of coating could resemble a mask similar to a mask at a masquerade ball, such that as the user removes that section of coating the user appears to be unmasking the doll 10.

In this figure tabs 51, 52 are seen. These tabs 51, 52 could be tabs of the same material which forms coating 30, allowing the user to grasp the tabs 51, 52 in order to more easily remove the coating sections to which the tabs are attached.

Alternatively, the tabs 51, 52 could be pieces of string, ribbon, or other fibrous material that are embedded in the coating 30 or otherwise adhered to it, such that the user can grasp the free ends of the string or ribbon and pull the associated sections of coating 30 away. Such tabs 51, 52, strings, ribbon, or other material define a means for the child to easily and without tools serially peel away the various sections of coating 30.

FIG. 4 shows the doll 10 of FIG. 1 with the user having peeled away additional layers of coating. Doll 10 now is nearly full revealed.

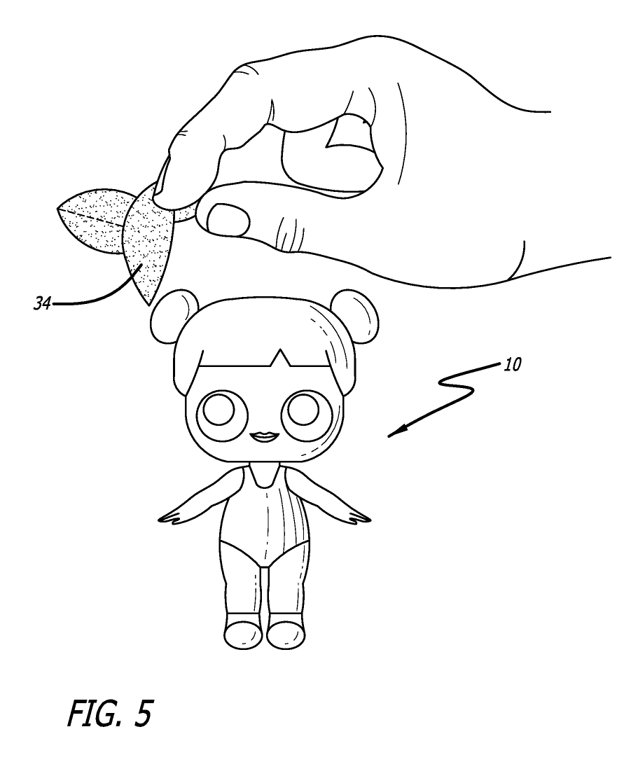

FIG. 5 shows doll 10 of FIG. 1 with the user having peeled away all of sections of coating 30, and with doll 10 now fully revealed. The transformation of doll 10 is now complete from what at first appeared to be a kitten due to the coating, to doll 10 revealed to be a little girl doll.

Coating 30 could be made of various materials, such as a suitable polymer. Suitable polymers are believed to include polyvinyl chloride (PVC), thermoplastic rubber (TPE), thermoplastic elastomer (TPE), Kraton®, silicone, or rubber. Coating 30 could be made of a wax such as paraffin wax, bees wax, microcrystalline wax, a combination of waxes such as is commonly used for waxing cheese, or other types of wax. Other types of coatings can be used as well, including hot-dip plastic coatings such as the type used to protect machine tools after manufacture and before use, or latex rubber. A coating that does not adhere strongly to the underlying toy is preferred so that it peels away easily. A thin layer of release coating such as silicone could be applied to the doll before the coating is applied to prevent strong adhesion of coating 30 to doll 10 and thus facilitate easy separation of coating 30 from doll 10. In the preferred embodiment the coating 30 is opaque or at least mostly opaque to conceal the doll 10 below. Alternatively, coating 30 could be semi-transparent so as to give the child a teasing or foreshadowing of the doll 10 within. Preferably the coating is a relatively thin coating, such as less than 1 mm, 2 mm, or 3 mm thick.

Coating 30 can have various colorings and shapes. Sections of coating 30 can be contoured to create large sized features such as the kitten ears in the embodiment shown, or could have smaller feature such as to provide facial expressions or facial features. The coating over the doll's hands could be shaped like a claw instead of a hand. The coating over the doll's feet could have the appearance of webbed feet similar to those of a duck. In this way, the doll's appearance and even what type of animal it is could change as the coating portions are peeled away to the reveal doll 10 below.

In another embodiment, at least one portion of the coating over the doll can be a brittle, easily broken, break-away coating, such as a weak plaster coating. For example, the coating over the eyes could be a break-away coating, while the coating over the rest of the doll's head is a polymer. Alternatively, the coating over the doll's head could be a polymer as in the first exemplary embodiment, and the doll's torso 24 could be covered in a breakaway coating. The child thus must use different techniques to reveal different parts of the doll, which additionally engages the child.

It will be appreciated that the term “present invention” as used herein should not be construed to mean that only a single invention having a single essential element or group of elements is presented. Similarly, it will also be appreciated that the term “present invention” encompasses a number of separate innovations which can each be considered separate inventions. Although the present invention has thus been described in detail with regard to the preferred embodiments and drawings thereof, it should be apparent to those skilled in the art that various adaptations and modifications of the present invention may be accomplished without departing from the spirit and the scope of the invention. For example, one or more materials other than materials mentioned herein could be used for the coating. The doll can have various appearances before and after the coating is removed. The coating could cover only a portion of the doll, such as the coating having the shape and appearance of one or more items of clothing such as a dress, such that as the child removes the coating the doll changes from having a first dress to a second dress, or from having boots to having sneakers or high heels. Accordingly, it is to be understood that the detailed description and the accompanying drawings as set forth hereinabove are not intended to limit the breadth of the present invention, which should be inferred only from the following claims and their appropriately construed legal equivalents.

We claim:

1. A toy having a coating which is peeled away in stages to gradually reveal the toy comprising:
a character figure;
a coating over the character figure, the coating comprising:
a first coating portion over a first part of the character figure; and
a second coating portion over a second part of the character figure; and
a separation line formed in the coating between the first and second coating portions such that
the first coating portion peels away from the doll without taking the second coating portion with the first coating portion.

2. The toy of claim 1 wherein:
the character figure without the coating has an appearance of a first species; and
the coating gives to the character an appearance of a second species;
such that when a user remove the coating from the character figure the character figure appears to transform from the first species to the second species.

3. The toy of claim 1 wherein the first and second coating portions are provided with tabs to facilitate the user peeling away said first and second coating portions.

4. The toy of claim 1 wherein the first and second coating portions have string embedded therein, the string having loose ends that protrude from the coating.

5. The toy of claim 1 wherein the coating comprises a polymer.

6. The toy of claim 1 wherein the coating comprises a material selected from the group consisting of polyvinyl chloride (PVC), thermoplastic rubber (TPE), thermoplastic elastomer (TPE), Kraton®, silicone, and rubber.

7. The toy of claim 1 wherein the coating comprises wax.

8. The toy of claim 1 wherein the separation line is selected from the group consisting of a perforation line and a die cut line.

9. The toy of claim 1 wherein the first and second coatings are peel-away coatings, and are conformed to a surface of the character figure.

10. The toy of claim 1 wherein:
the first coating portion covers a first eye of the character figure; and
the second coating portion covers a face of the character figure.

11. The toy of claim 10 further comprising:
a third coating portion covering hair on the character figure.

12. The toy of claim 10 further comprising a third coating portion covering a second eye of the character figure, and wherein:
a first separation line facilitates separation of the first coating portion from the second coating portion, and
a second separation line facilitates separation of the third coating portion from the second coating portion.

13. A toy having a conformal coating which is peeled away in stages to gradually reveal the toy comprising:
a character having a head;
a coating over at least part of the character's head, the coating conforming to an exterior surface of the character's head; and
a weakened separation line formed within the coating to facilitate a user peeling away a first portion of the coating without also peeling away a second portion of the coating;
whereby a child can, without any tools, first remove only the first portion of coating thus revealing only a first portion of the character's head, and then remove the second portion of the coating thus revealing a second portion of the character's head.

14. The toy of claim 13 wherein:
the character without the coating has an appearance of a first species; and
the coating gives to the character an appearance of a second species;
such that when a user removes the coating from the character the character appears to transform from the first species to the second species.

15. The toy of claim 13 wherein the first and second portions of coating are adjacent on the character before they are removed.

16. The toy of claim 13 further comprising means for the child to grasp in order to easily and independently peel away the first and second coating portions from the character.

17. A toy having a coating thereon which is peeled away in stages to gradually reveal the toy comprising:
a character, the character having an exterior surface;
a first coating portion over a first portion of the exterior surface;
a second coating portion over a second portion of the exterior surface;
a first means for easily removing the first coating portion from the character; and
a second means for easily removing the second coating portion from the character;
wherein when the first means is used to remove the first coating portion from the character to reveal a first feature of the character below, the second coating portion remains on the character.

18. The toy of claim 17 wherein:
the first and second coating portions each comprise a first coating material; and
the first material has a separation line formed therein, the separation line demarking the first and second coating portions.

19. The toy of claim 17 further comprising a release coating between the character and the first and second coating portions, the release coating preventing the coating portions from adhering strongly to the character thereby facilitating release of the coating portions from the character.

20. The toy of claim 17 wherein at least one of the coating portions has an animal feature formed therein, and the character does not have the animal feature as a feature of the character.
